(19) United States
(12) Patent Application Publication
(10) Pub. No.: US 2013/0110532 A1
(43) Pub. Date: May 2, 2013

(54) SYSTEM AND METHOD FOR MANAGING PATIENT TREATMENT

(71) Applicant: WELLPOINT, INC., Chicago, IL (US)

(72) Inventors: Prakash Upadhyayula, Plainfield, IL (US); Aruna Guruprasad, Lodi, NJ (US); Ashok Chennuru, Powell, OH (US); Andrew J. Lang, Avon, CT (US)

(73) Assignee: WELLPOINT, INC., Chicago, IL (US)

(21) Appl. No.: 13/660,598

(22) Filed: Oct. 25, 2012

Related U.S. Application Data
(60) Provisional application No. 61/561,423, filed on Nov. 18, 2011.
(60) Provisional application No. 61/561,421, filed on Nov. 18, 2011.
(60) Provisional application No. 61/561,414, filed on Nov. 18, 2011.
(60) Provisional application No. 61/554,587, filed on Nov. 2, 2011.
(60) Provisional application No. 61/554,021, filed on Nov. 1, 2011.
(60) Provisional application No. 61/553,507, filed on Oct. 31, 2011.
(60) Provisional application No. 61/553,144, filed on Oct. 28, 2011.

(51) Int. Cl. G06F 19/00

(52) U.S. Cl. CPC G06F 19/328
USPC 705/2

(57) ABSTRACT

Data describing a request to identify a treatment option for a patient associated with a diagnosis for the patient is received. In response to the request, data describing a treatment bundle is identified. The treatment bundle includes a plurality of treatments, the treatments include one or more of a procedure, a test, a medication, and a therapy. An insurance claim for the treatment bundle is processed.

### CROSS REFERENCE TO RELATED APPLICATIONS

This application claims priority to U.S. Provisional Patent Application Nos. 61/553,144, filed Oct. 28, 2011, 61/553,507, filed Oct. 31, 2011, 61/554,021, filed Nov. 1, 2011, 61/554,587, filed Nov. 2, 2011, 61/561,414, filed Nov. 18, 2011, 61/561,421, filed Nov. 18, 2011, and 61/561,423, filed Nov. 18, 2011, the entireties of which are incorporated herein by reference.

### FIELD OF THE INVENTION

The systems and methods described herein relate to managing patient treatment.

### SUMMARY OF EMBODIMENTS OF THE INVENTION

The present invention is directed to systems, methods and computer-readable media for use in connection with managing patient treatment. In one embodiment, data describing a request to identify a treatment option for a patient associated with a diagnosis for the patient is received. In response to the request, data describing a treatment bundle is identified. The treatment bundle comprises a plurality of treatments, the treatments comprising a one or more of a procedure, a test, a medication, and a therapy. An insurance claim for the treatment bundle is processed. In some embodiments, a request for pre-authorization of the treatment bundle is processed. In other embodiments, a payment to one or more providers providing services associated with the treatment bundle is initiated.

In a further embodiment, data describing a treatment bundle for a patient is received. The treatment bundle includes a plurality of treatments, the treatments comprising a one or more of a procedure, a test, a medication, and a therapy. In some embodiments, an insurance claim for the treatment bundle is processed. In other embodiments, a request for pre-authorization of the treatment bundle is processed. In still other embodiments, a payment to one or more providers providing services associated with the treatment bundle is initiated. In further embodiments, data describing validation of the data describing the treatment bundle based on one or both of medical literature information and patient medical history information is received.

### BRIEF DESCRIPTION OF THE DRAWINGS

FIG. 1 is a diagram illustrating an example of the logical workspace of a decision support system of one embodiment of the present invention;

FIG. 2 is a diagram illustrating an example of the functionality that may be employed in connection with the decision support system of one embodiment of the present invention;

FIGS. 3A-3G are flow diagrams illustrating exemplary methods of the present invention;

FIGS. 4A-4Q are exemplary user interfaces that may be used in connection with an exemplary embodiment of the present invention;

FIG. 5 is a diagram of an exemplary system that may be used to carry out the processes of an embodiment of the present invention; and

FIG. 6 is a diagram of an exemplary system illustrating exemplary computer hardware and software components that may be used in connection with an embodiment of the present invention.

### DETAILED DESCRIPTION

The decision support information rendering systems described herein provide an information rendering process that facilitates making evidence-based decisions. In one embodiment, the information rendering process is integrated with machine learning to facilitate efficient decisioning through automated decision recommendation display, and also allows for tracking user behavior during the process. Certain embodiments of the information rendering process also quantify behavior of decision makers through definition of specific behavior tracking metrics, decision trend measurements, and instrumentation for calibrating measurements.

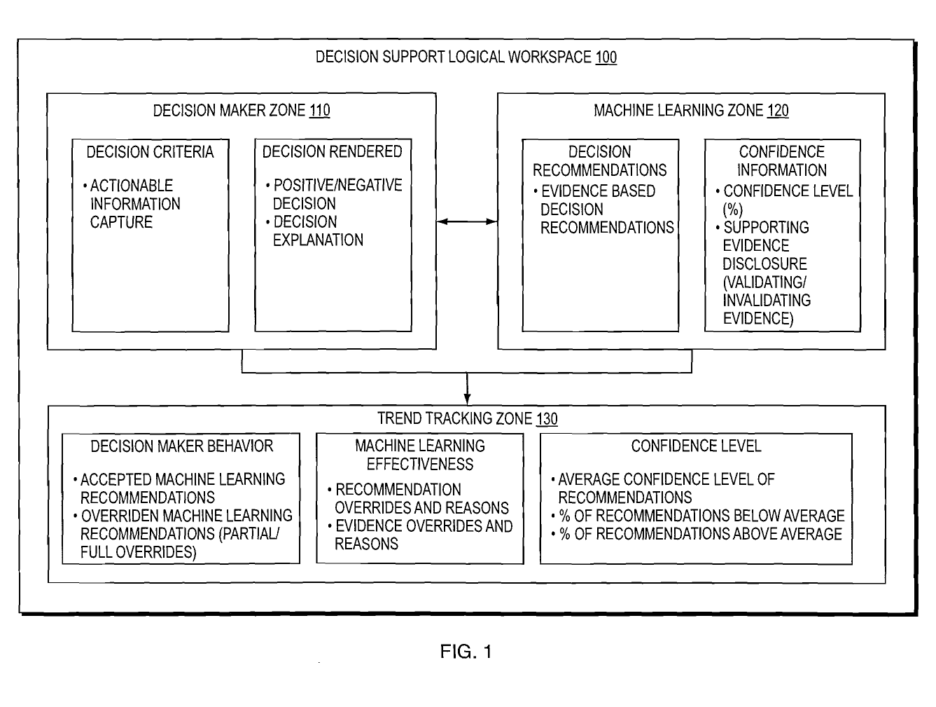

In one embodiment, the decision support information rendering system defines a workspace designed specifically for decision makers. The workspace 100 is composed of three logical zones, in an exemplary embodiment. FIG. 1 illustrates the logical decomposition of the workspace and the relationships between the components. The decision maker zone 110 is designed to capture actionable information through human-machine interactions or automated data capture. This zone 110 also captures the decision rendered by decision makers and the explanation for rendered decisions. The machine learning zone 120 is designed to capture decision recommendations from machine learning components as well as associated supporting evidence and the confidence level of the recommendation. The trend tracking zone 130 is designed to detect and track decision support trends including behavior of decision makers in terms of accepting or overriding machine learning recommendations, the effectiveness of machine learning recommendations and effectiveness of supporting evidence as well as the overall trend of confidence level in recommendations and rendered decisions.

Systematic and user friendly rendering of information in a decision support system can be a complex problem. The human-computer interaction models for decision support systems involve multiple categories of information that need to be rendered in a structure that facilitates a decision maker to make right decision at the right time. This implies that information needs to be structured for quick actions that lead or guide a decision maker towards the right decision path.

By defining a logical workspace specifically for decision support, the decision support information rendering system is able to compartmentalize information into actionable events. For example, a decision maker zone 110 renders information specifically necessary for a particular type of decision. Approval of a pre-authorization or approval of a treatment regiment is a specific decision type, by way of example. However, the system is equally applicable to other decision types. Decision maker zones 110 can be designed to align with one or more types of decisions. The machine learning zone 120 maintains a logical separation from decision makers, which clarifies and supports the notion that the primary responsibility for decisions lies with decision makers. Machine learning is responsible only for recommending the right decision at the right time based on the type of decision to be rendered. The trend tracking zone 130 monitors the decision makers' behavior and the effectiveness of machine learning throughout the decision making process. Separating the trend tracking zone 130 from other zones in the workspace creates the flexibility to make trend data visible or invisible depending on the type of decisions. In some instances, the trend tracking zone 130 could be entirely invisible or, in other situations, every measurement and data point on the trend curve can be visible. The overall structuring of the logical workspace can be implemented natively on different system platforms.

One embodiment of the decision support information rendering system includes the following characteristics of the decision support logical workspace: (1) disclosure of supporting evidence to decision recommendations; (2) historical decisions and associated reasons for specific decision types and decision criteria; (3) overriding behavior of decision makers; and (4) opportunity to improve evidence based on decision trends and decision maker behaviors. Disclosure of evidence supporting decision recommendations creates greater transparency into decision recommendations. These recommendations could come from machine learning sources or other experience, predictive and simulation sources. Regardless of the recommendation source, the disclosure of supporting evidence enables decision makers to quickly accept or override specific decision recommendations. Access to historical decisions and any associated reasons (e.g., in the form of decision maker notes) allows decision makers to quickly adopt decision trends. This is an important characteristic from an exceptional scenario perspective. For example, when a decision maker encounters an exceptional decision criterion, historical decisions and decision trends help decision makers maintain consistency of decisions rendered. Despite the advances in machine learning, decision recommendations are not 100% accurate yet. There is some level of uncertainty within each decision recommendation. This uncertainty is reflected in the confidence level associated with decision recommendations. By allowing decision makers to override decision recommendations and tracking the different decision maker's behavior relative to specific decision types, the decision support information rendering system creates opportunities to improve future machine learning recommendations. If decision maker behaviors are in conflict with decision trends, then appropriate corrective measures can be made to improve the decision recommendations. Improving supporting evidence based on decision trends and decision maker behaviors creates a feedback mechanism for the decision support information rendering system. The percentage of supporting evidence that needs changes or improvements will drive higher levels of effectiveness in utilizing machine learning.

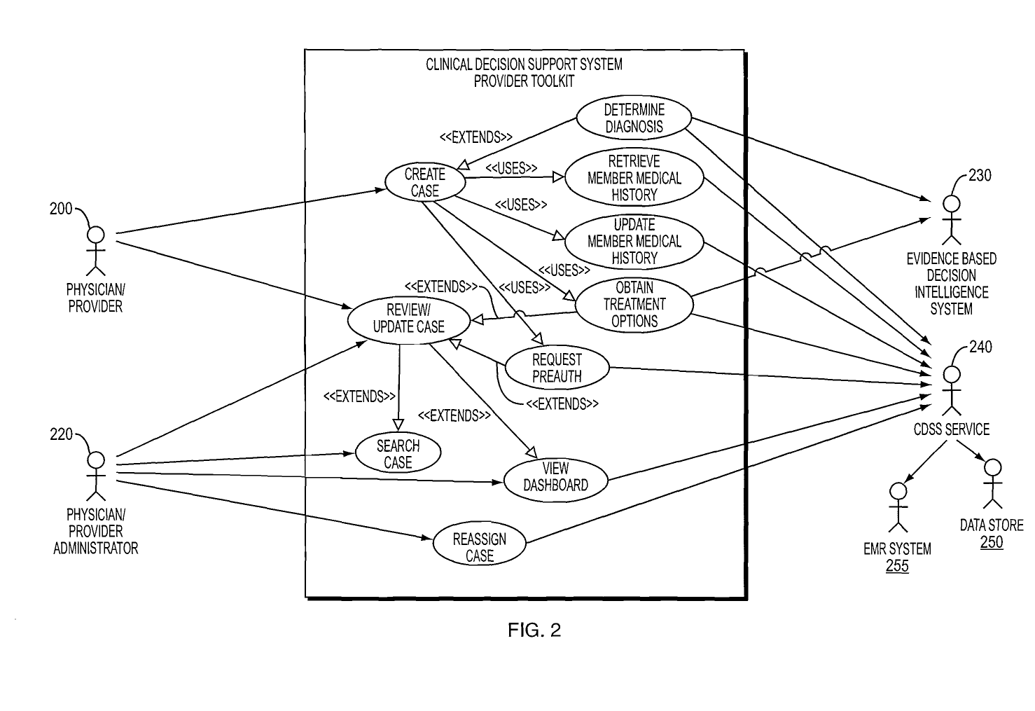

By way of example, FIG. 2 illustrates the features of the Physician/Provider Toolkit of the Clinical Decision Support System and its information rendition functions involving the primary actors (e.g. Clinical Staff, Administration etc), the decision support system and machine learning components. User 200 may access the create case feature of the system, including determining a diagnosis, retrieving member medical history, updating member medical history and obtaining treatment options, employing the evidence based decision intelligence system and CDSS system 240, which accesses data store 250 and electronic medical record system 255. User 200 may also access the review/update case functionality of the system. User 200 may be an administrator, and can access the review/update case, search case, reassign case, and view dashboard functionality of the system, employing CDSS system 240, data store 250 and electronic medical record system 255.

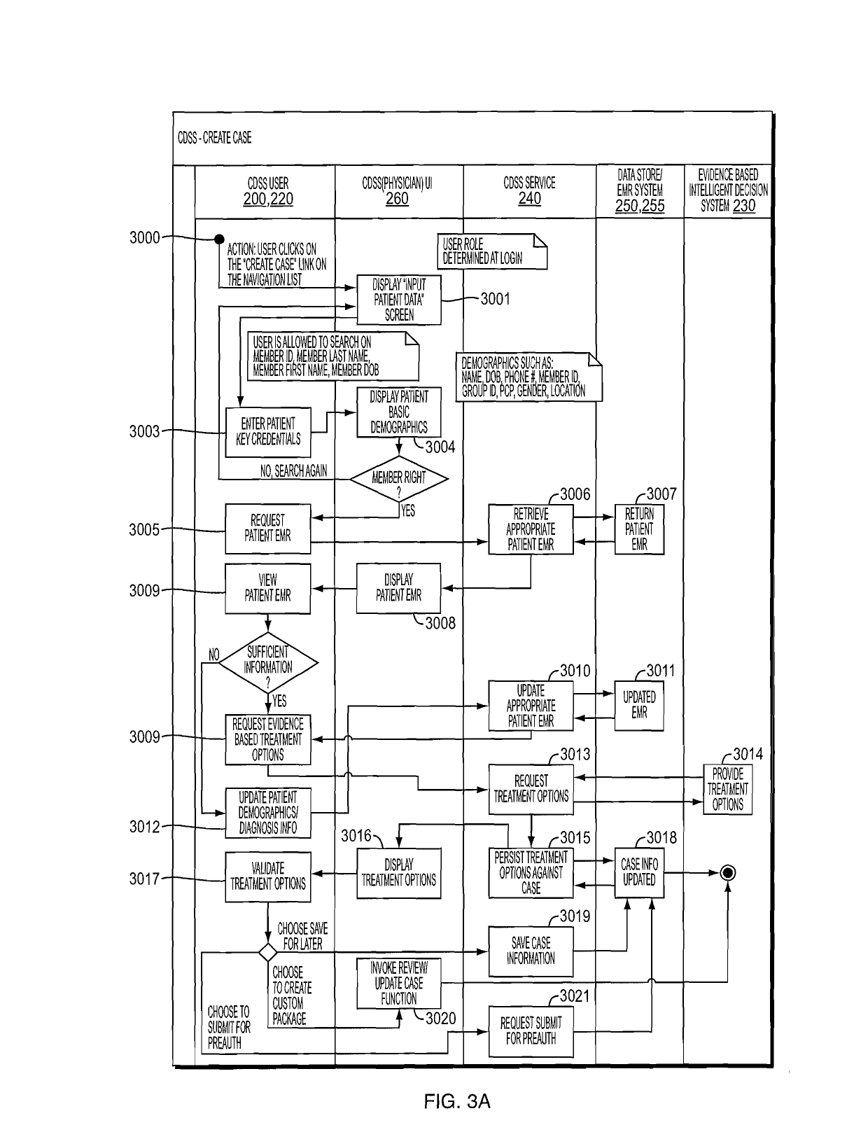

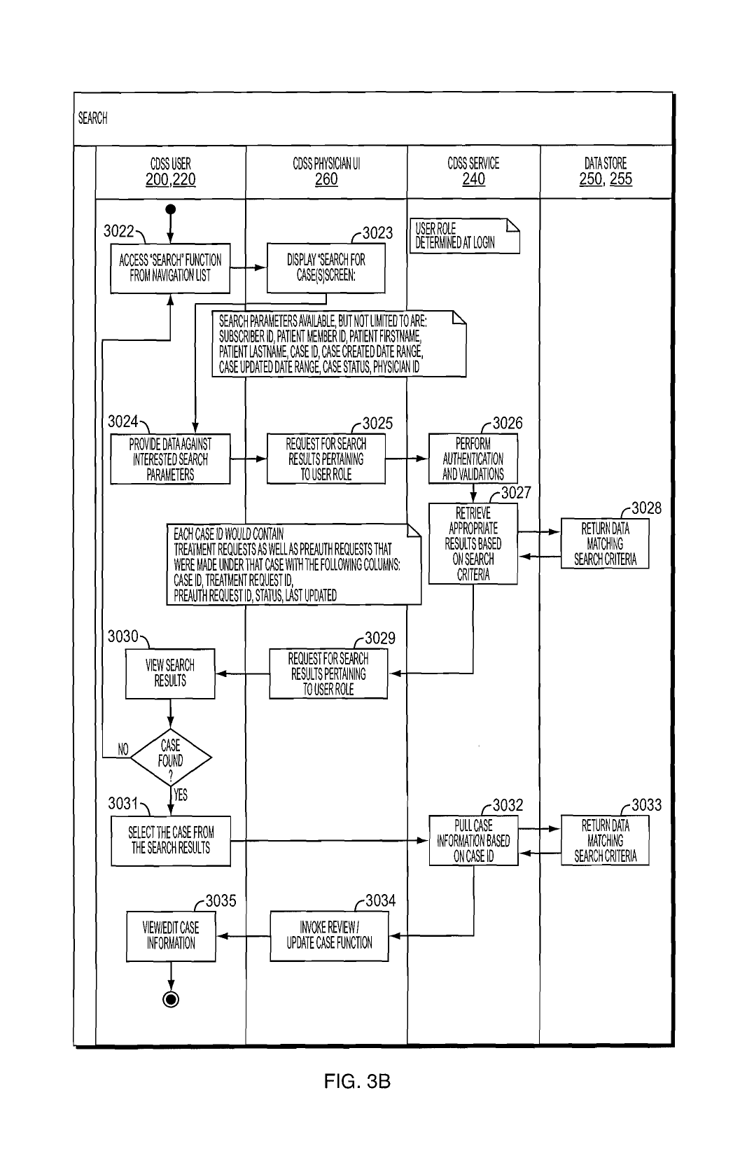

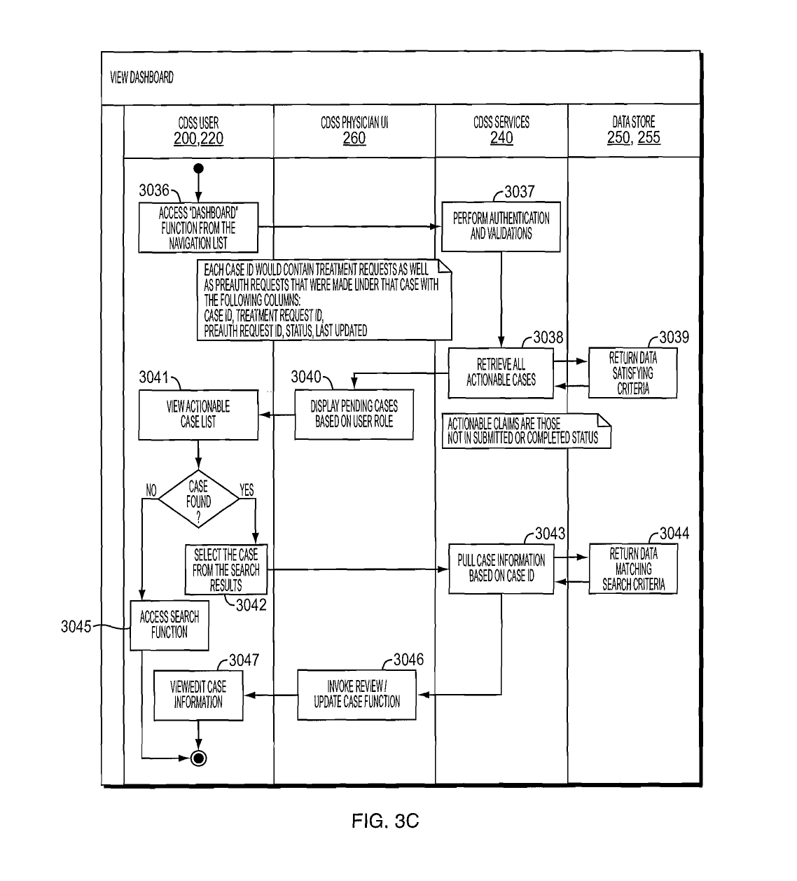

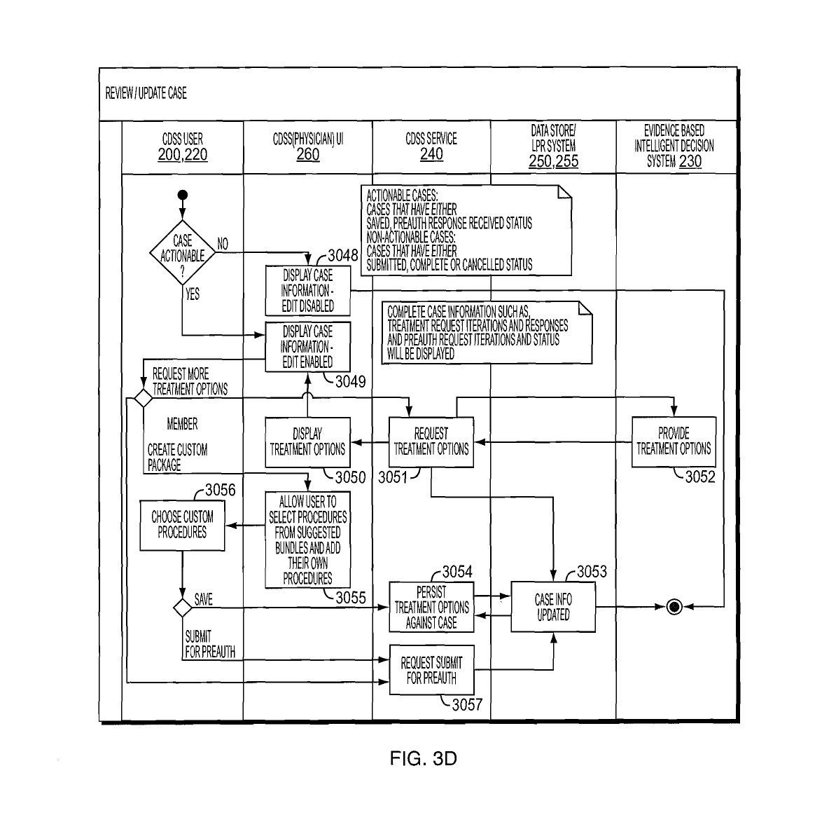

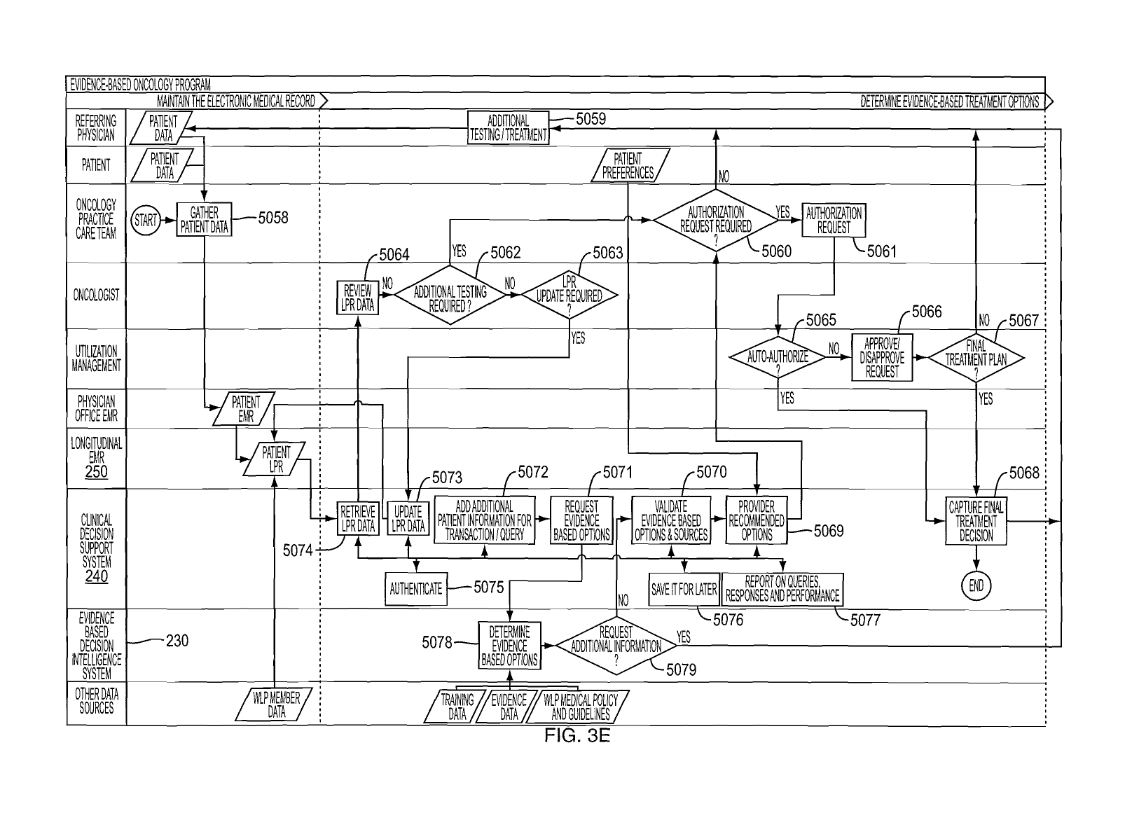

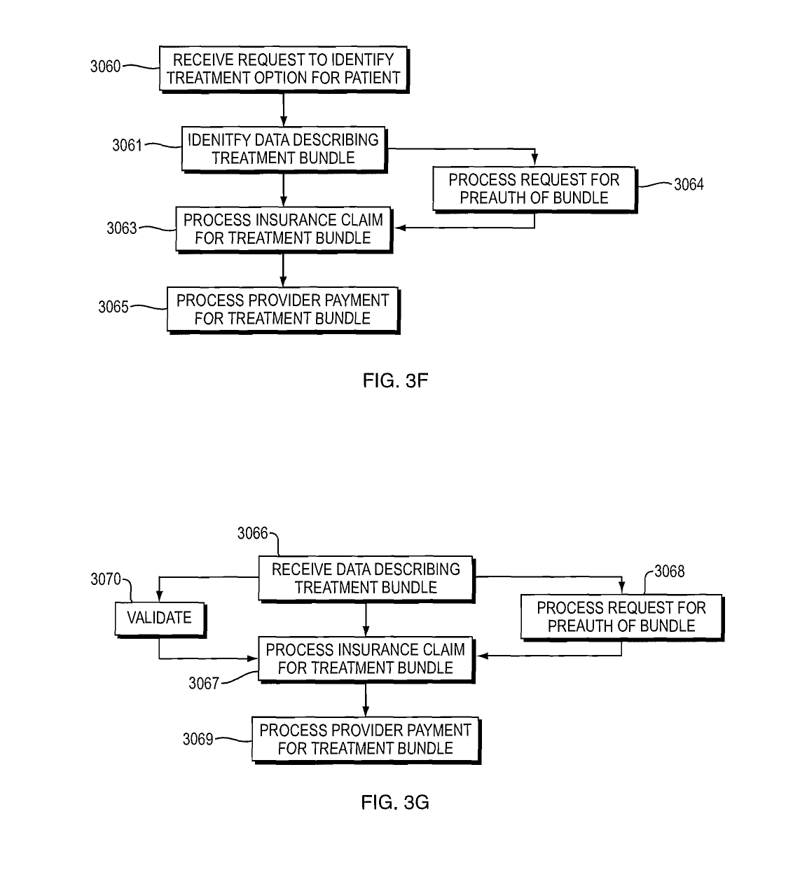

FIG. 3A is a flow diagram illustrating an exemplary workflow of the “Create Case” feature that may be part of one embodiment of the Physician/Provider Toolkit of the Clinical Decision Support System. The user interface 260 displays the consolidated patient information, allows the user to edit the information, displays the treatment bundles, allows the user to choose from the available bundles or to create their own, and save or submit the bundle for preauthorization. The CDSS Service 240 authenticates the request, validates the information received, handles persistence of the request and response from the decision intelligence system, and provides the decision suggestions/treatment bundles to the user interface. It also handles the retrieval of member information from the electronic medical record system 255 and updating of new information received from the physician/provider back into the electronic medical record system 255. The data store 250 captures and stores information received and displayed to the users and their feedback on the recommendations.

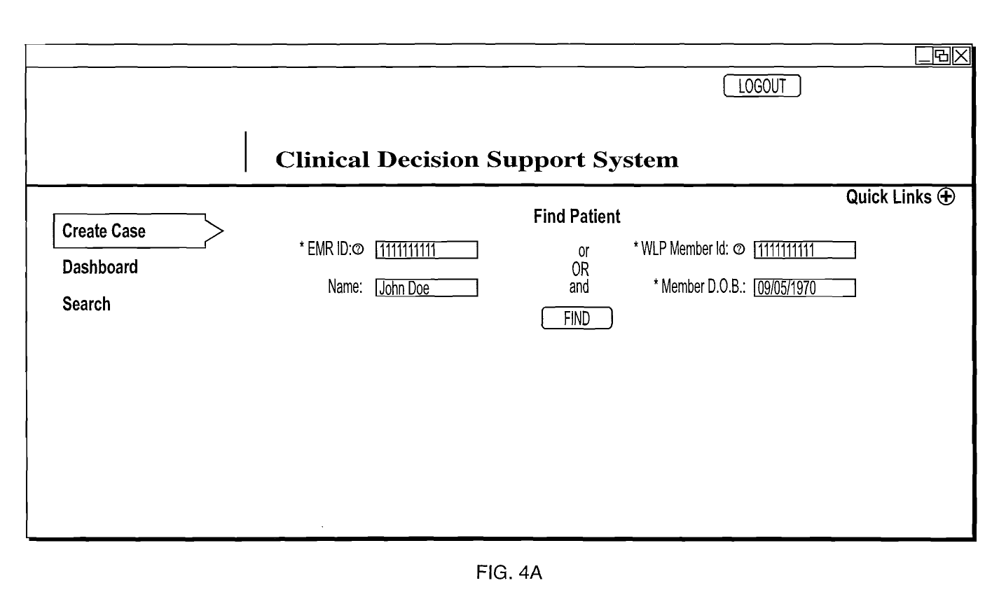

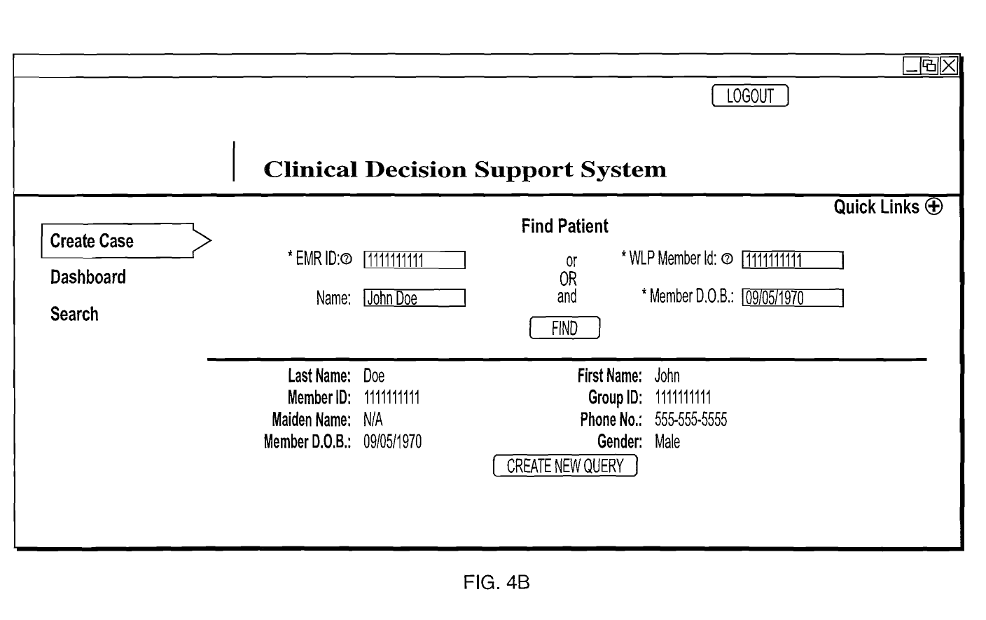

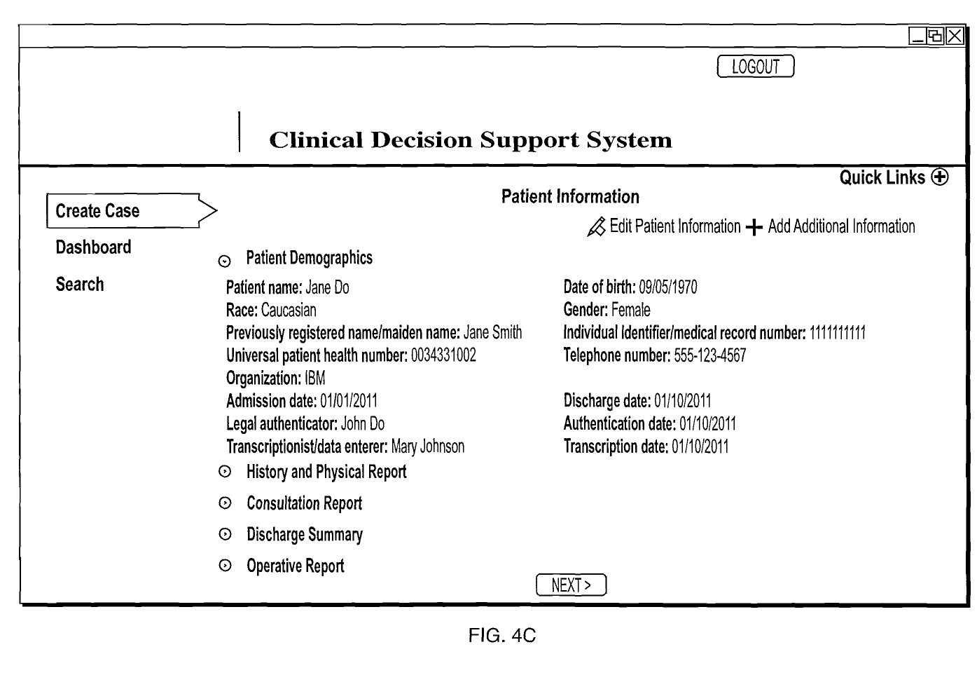

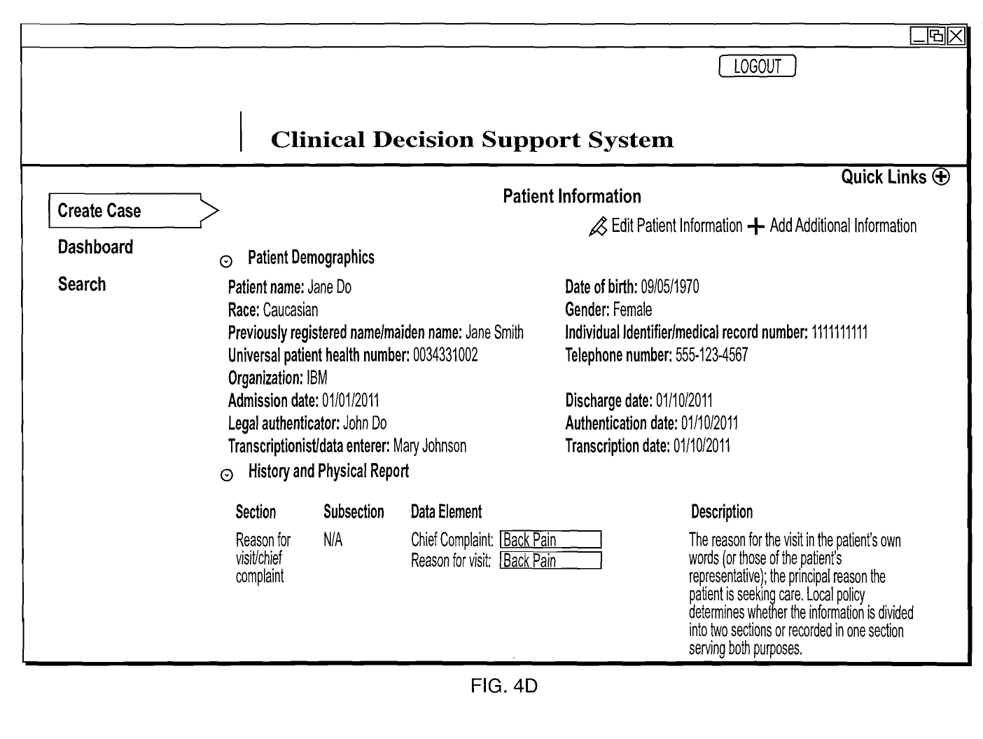

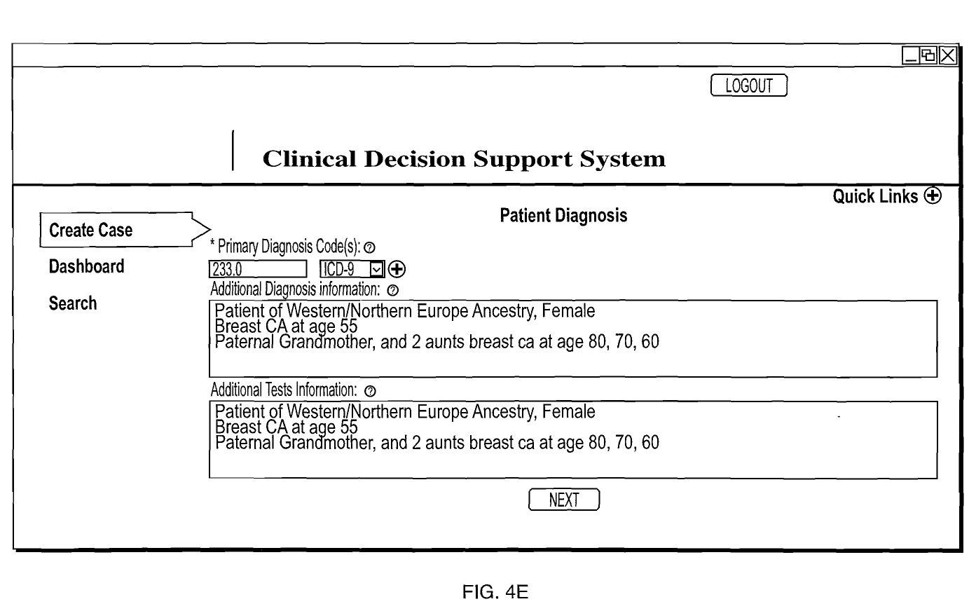

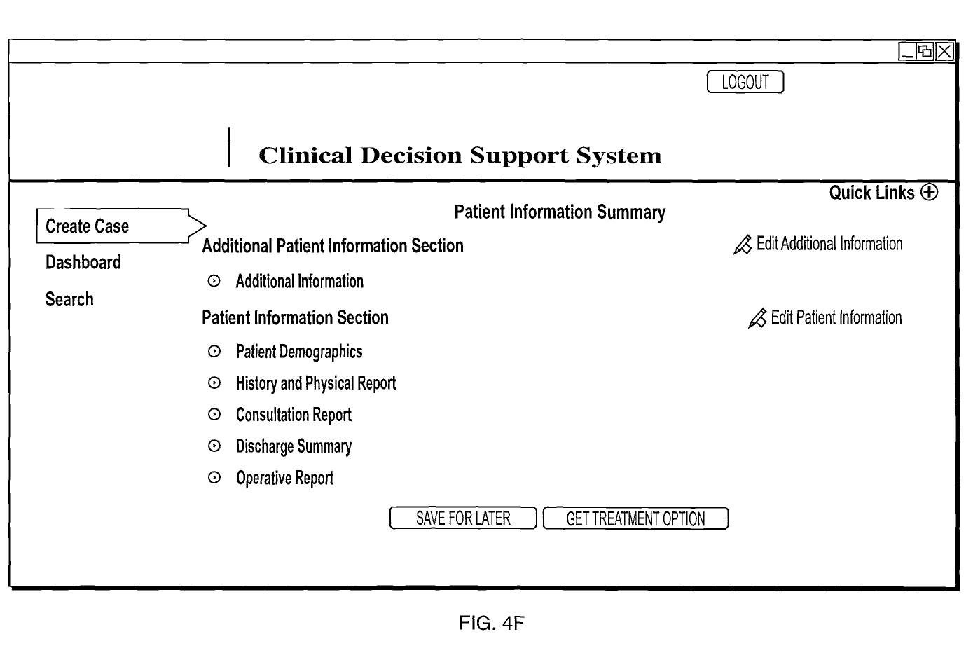

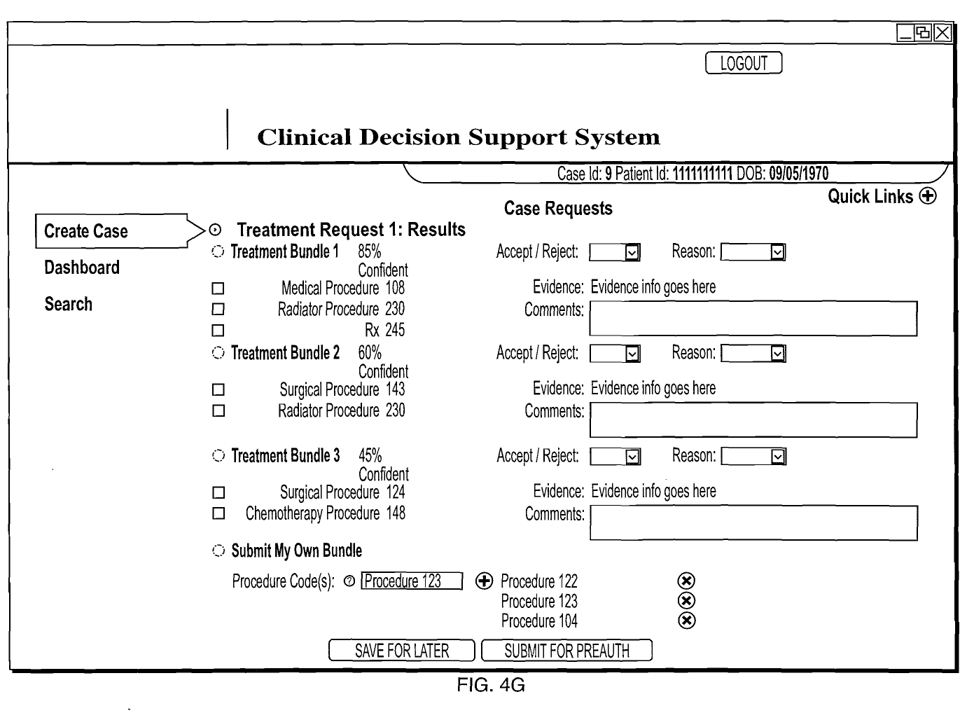

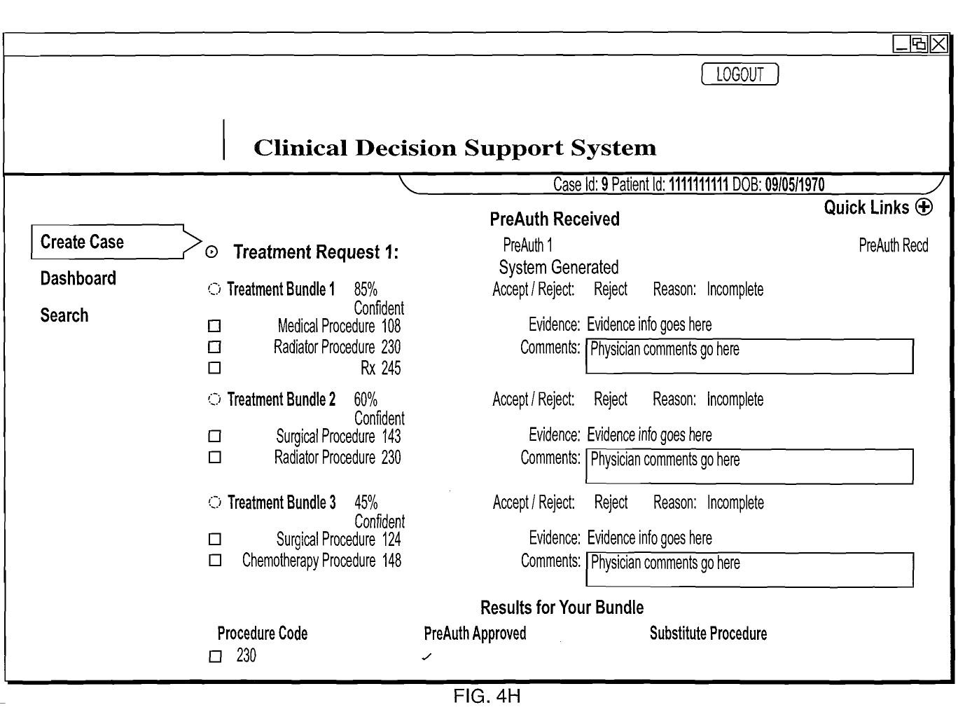

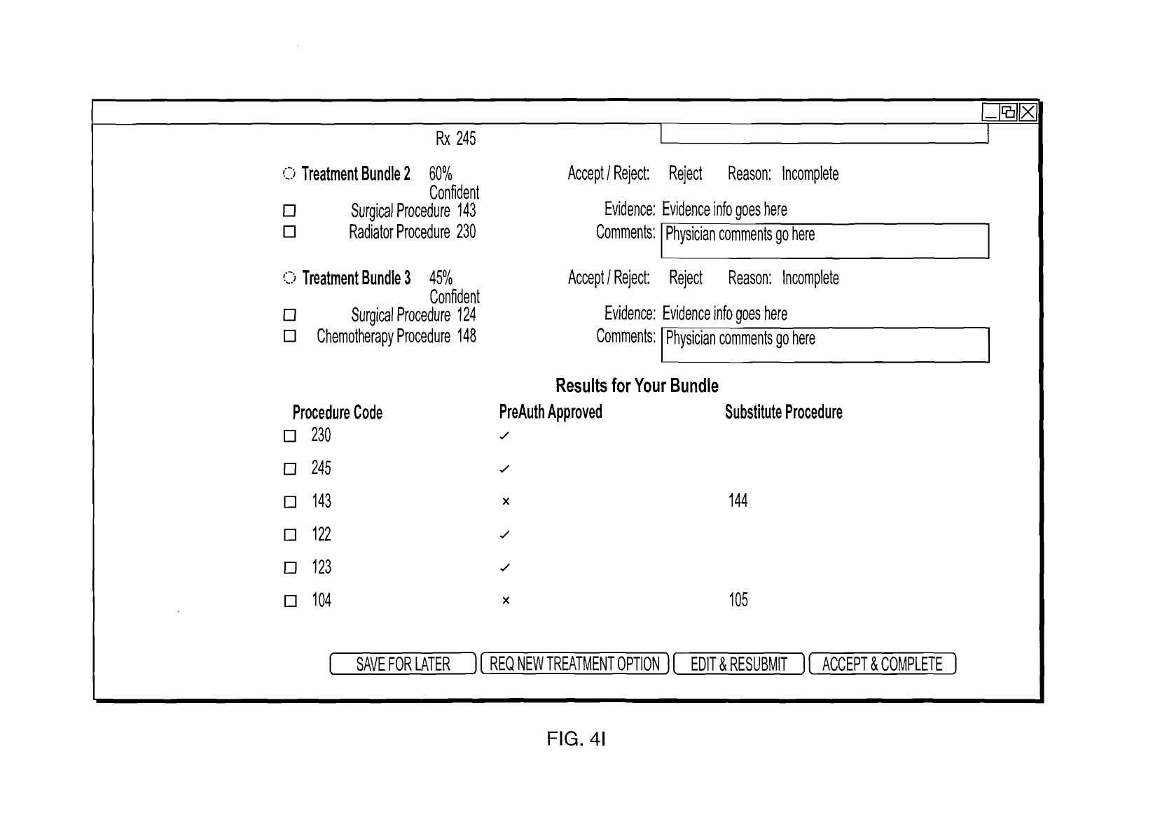

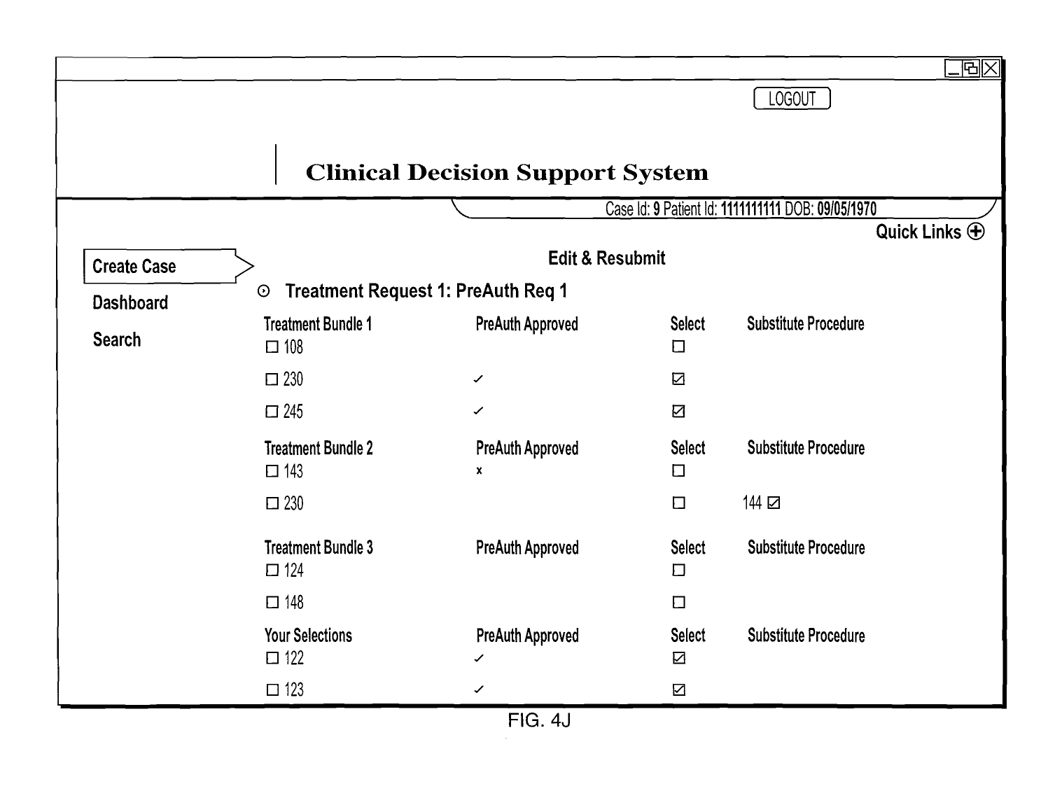

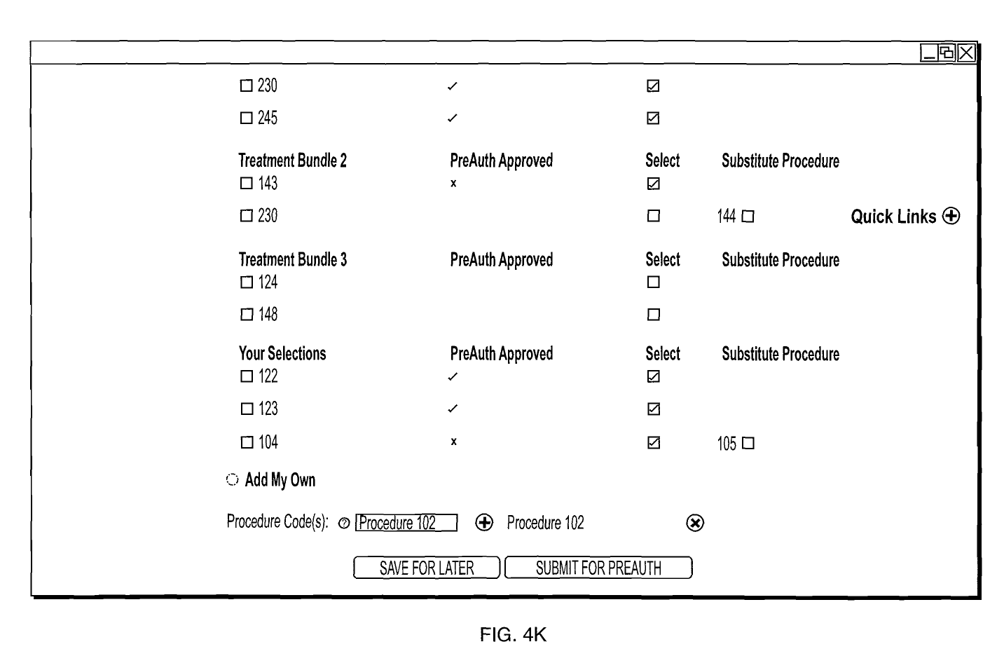

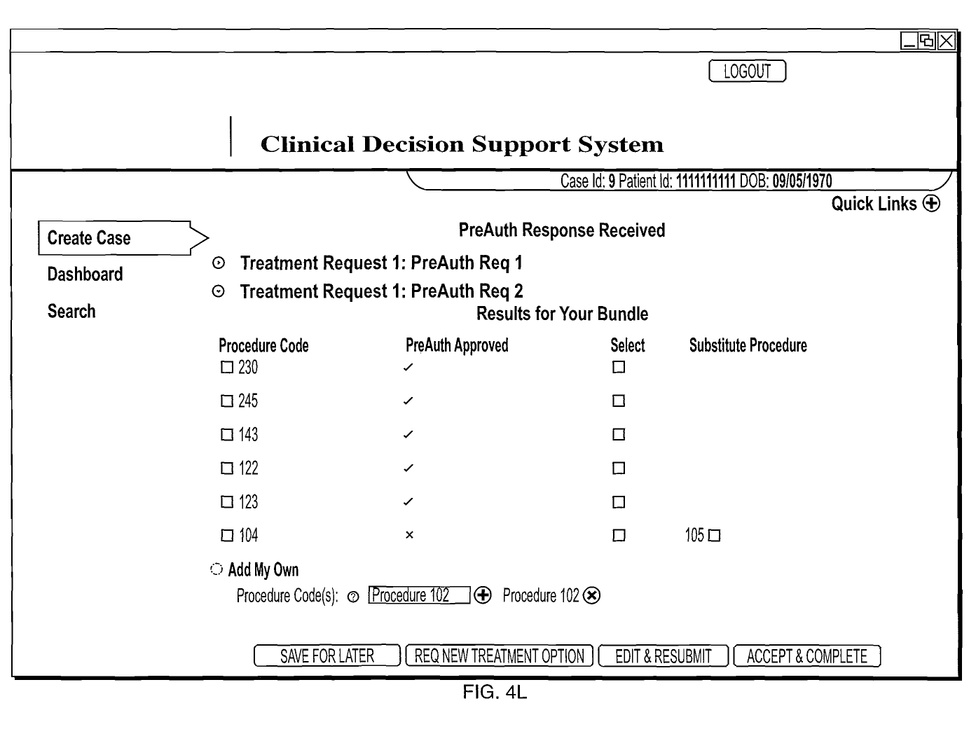

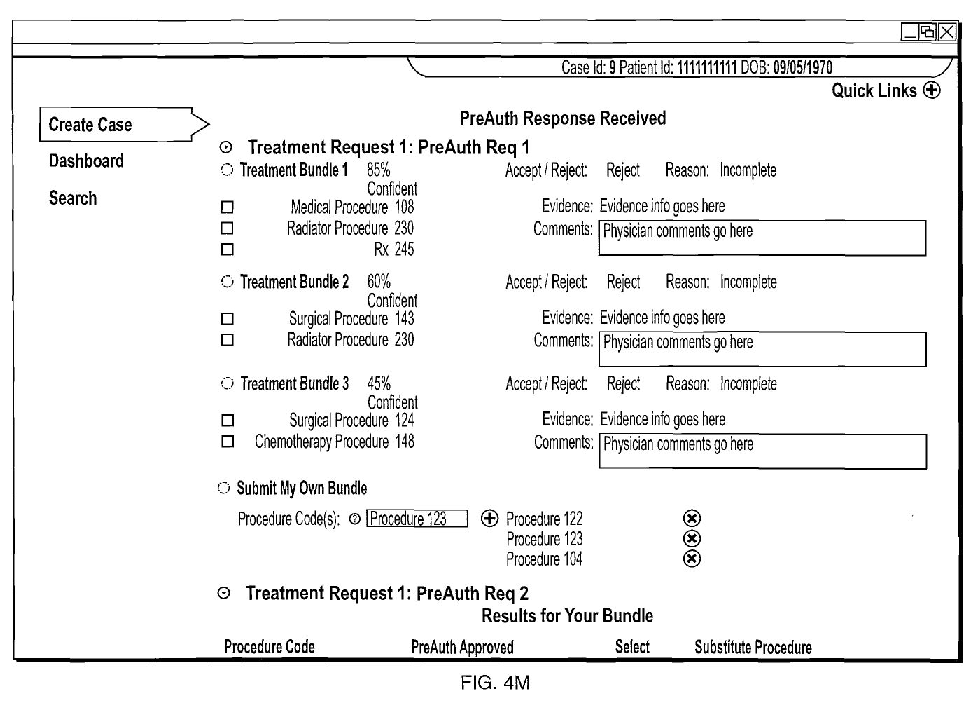

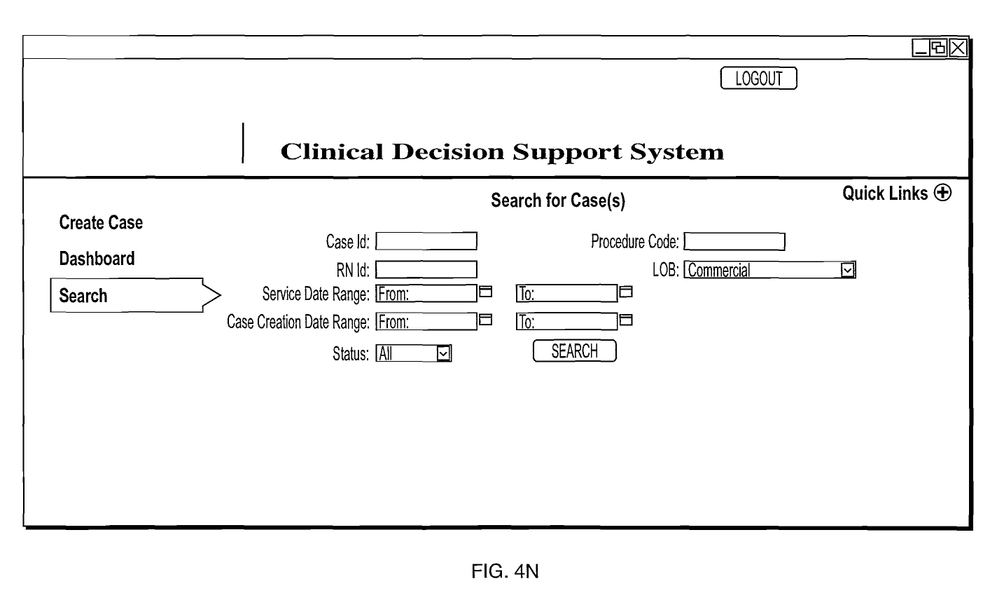

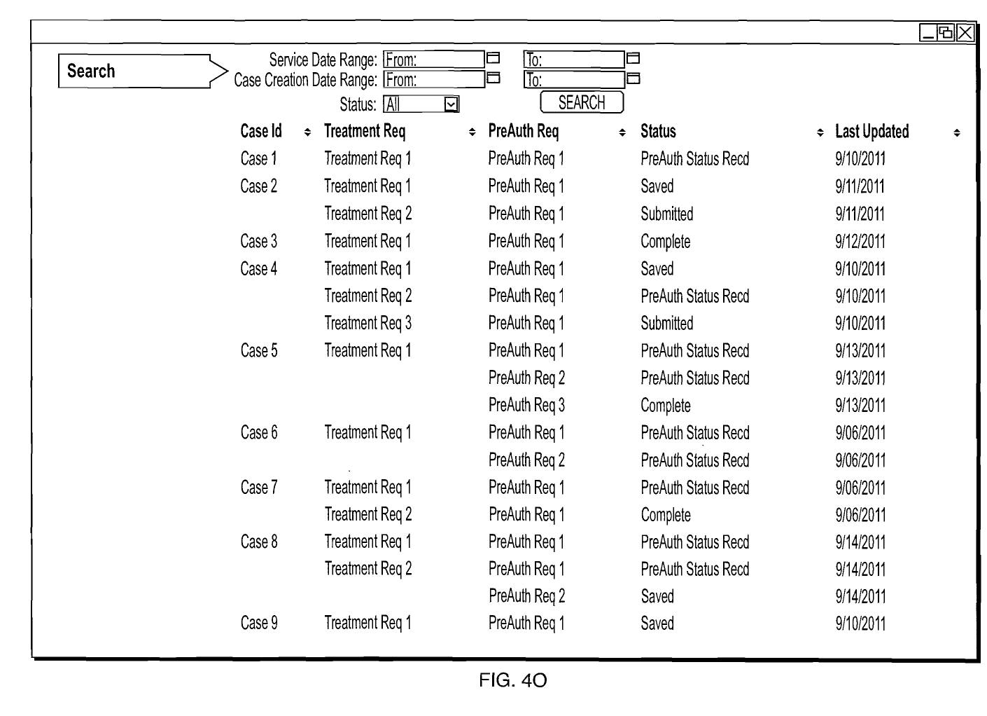

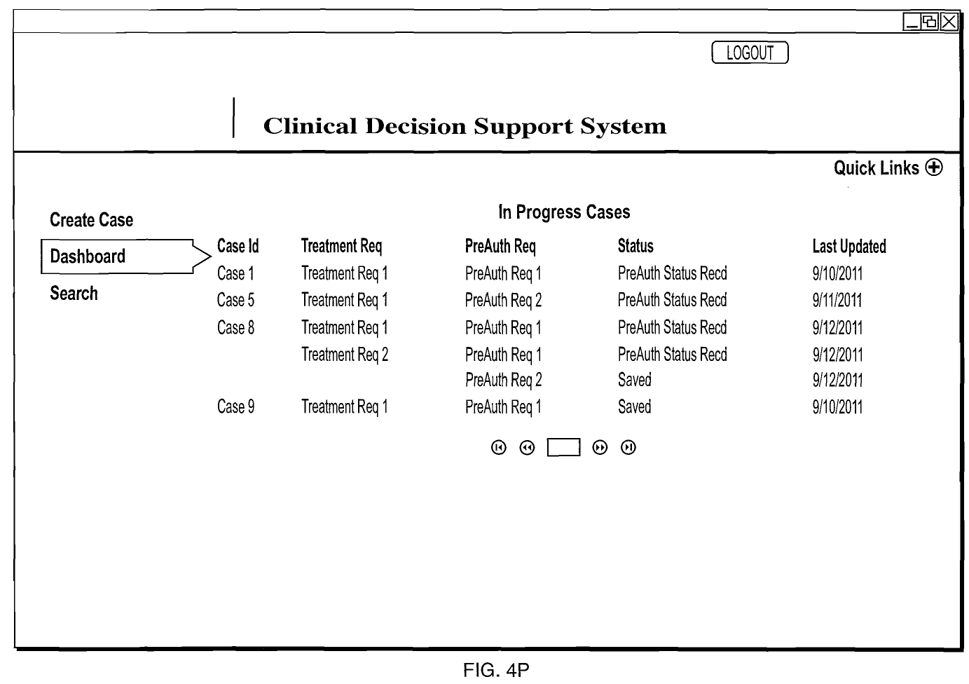

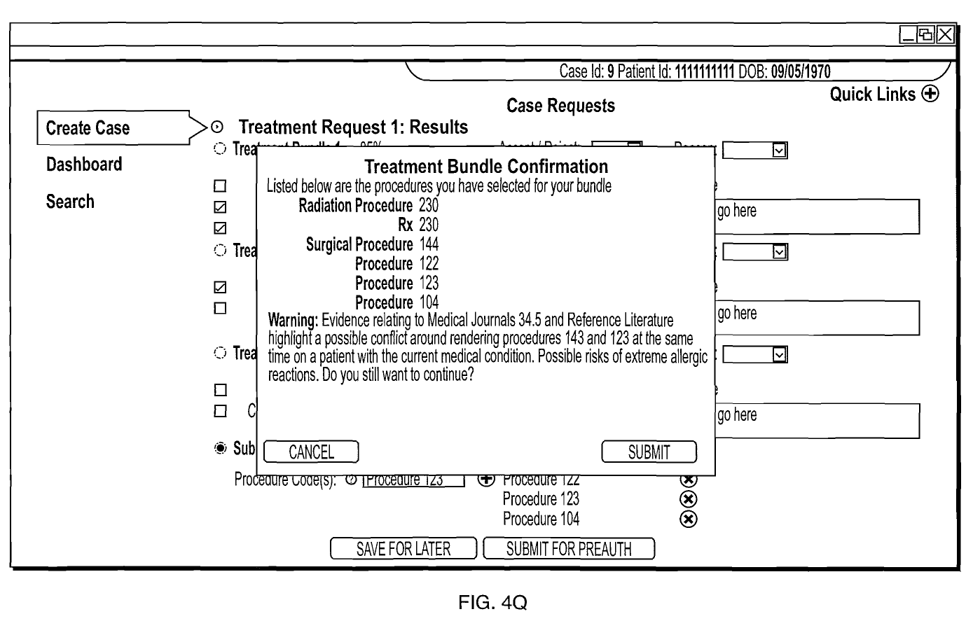

The screens shown in FIGS. 4A-4M illustrate an exemplary sequence of actions a provider/physician may take to create a case and save or submit it for Preauthorization through the Clinical Decision Support System.

FIG. 4A illustrates an exemplary “Find Patient” screen. The physician/provider can search by Patient Demographics in one embodiment. FIG. 4B illustrates an exemplary screen in which additional basic demographic confirmation of the member can be achieved. FIG. 4C illustrates an exemplary “Patient Information” screen where the physician/provider can review information and further edit or add more information. FIG. 4D illustrates the “Patient Information” screen where the physician/provider can edit information by scrolling to sections of the screen with editable fields. These updates may be made, e.g., based on the provider's discussions with the patient. FIG. 4E illustrates the “Patient Information” screen where the physician/provider can provide his diagnosis and other additional information from his analysis of the patient. FIG. 4F illustrates a “Patient Information Summary” screen where the physician/provider can confirm that all the medical details for the patient are correct and proceed to obtain treatment options/suggestions from the system. FIG. 4G illustrates a “Case Request: Treatment Option Response” Screen. In this screen, the physician/provider is provided suggestive treatment bundles for the patient. After the physician/provider validates all the treatment bundles generated by the system, by choosing the appropriate values from the drop down and providing their comments, the physician/provider can make his selections or create his own treatment bundle and save for later or submit for preauthorization. FIG. 4H illustrates a “Case-PreAuth Response Received Screen Part 1”. Here, the physician/provider is provided information regarding system-generated options and the preauthorization responses on his bundle of requested procedures. FIG. 41 illustrates a “Case—PreAuth Response Received Screen Part 2” (i.e., the second part of the screen shown in FIG. 4H). Here, the physician/provider is provided information regarding system generated options and the preauthorization responses on the requested procedures.

FIG. 4J illustrates the “Edit and Resubmit Screen: Part 1”. If the user chooses to Edit and Resubmit, then the user will be allowed to re-choose procedures and create a new bundle for submission. FIG. 4K illustrates a “Edit and Resubmit screen: Part 2” (i.e., the second part of the screen shown in FIG. 4J). Here, if the user chooses to Edit and Resubmit, then the user will be allowed to re-choose procedures and create a new bundle and submit for preauthorization. FIG. 4L illustrates the “PreAuth Response Iteration 2.” Here, if the user chose to submit for Preauthorization a second time, the pre-authorization response will be displayed, e.g., as in this screen, with the information of the previous PreAuth request iteration collapsed in an accordion. FIG. 4M illustrates the “PreAuth Response Iteration 2.” If the user expands the accordion in the previous screen, he will be shown the details of the previous iteration.

By way of further example, with reference to FIG. 3A, after logging on, the user 200/220 may click on the Create Case link on the navigation list, in step 3000. In step 3001, the user interface 260 displays the input patient data screen. In step 3003, the user 200/220 can search on basic patient information such as Member Id, Member Last name, Member First Name, and Member DOB, by way of example. In step 3004, user interface 260 displays the basic patient demographics. If the displayed patient information is that being sought by the user 200/220, in step 3005, the user can request the patient's electronic medical record. In step 3006, the CDSS Service 240 retrieves the appropriate patient electronic medical record from electronic medical record system 255, which is returned in step 3007, and displayed to the patient in step 3008.

In step 3009, the user 200/220 can view the patient electronic medical record. If the information displayed is sufficient, in step 3009, the user 200/220 may request evidence based treatment options. In step 3013, the CDSS Service 240 requests treatment options, which are provided in step 3014 by the evidence based intelligent decision system 230. In step 3015, the treatment options are persisted against the case by CDSS service 240, and data store 250 is updated with the case information. In step 3016, the user interface 260 displays the treatment options. In step 3017, the user 200/220 can validate the treatment options. At this point, in one embodiment, three paths are available to the user 200/220. In step 3019, the case information can be saved for later action, at which point the case information is updated in data store 250, in step 3018. Alternatively, the user 200/220 can choose to create a custom package. In this instance, in step 3020, the user interface 3020 invokes the review/update case functionality. As a further alternative, the user 200/220 can chose to submit the treatment option(s) for preauthorization. In this instance, CDSS service 240 submits the case for preauthorization in step 3021, and the case information is updated in data store 250 in step 3018. If the information returned in step 3009 is not sufficient, in step 3012, the user 200/220 can update the patient demographic/diagnosis information. In step 3010, the CDSS service 240 updates this information in the patient electronic medical record system 255, which is stored in step 3011. Then, returning to step 3009, the user 200/220 can request evidence based treatment options and the process begins again.

FIG. 3B is a flow diagram illustrating an exemplary workflow of the “Search for Case(s)” feature that may be part of one embodiment of the Physician/Provider Toolkit of the Clinical Decision Support System. The user can search for cases based on parameters, including, but not limited to, Subscriber ID, Patient Member ID, Patient First name, Patient Last name, Case ID, Case Created Date Range, Case Updated Date Range, Case Status, and Physician ID, by way of example. The cases that match the search criteria requested may be displayed, with the hierarchy of treatment options requests and preauthorization requests for each case. The user can then choose any case in the displayed list to go through the screens/functions available for reviewing and updating these cases. Thus, with reference to FIG. 3B, in step 3022, upon logging in, the user 200/220 can access the “Search” function from the navigation list. In step 3023, the user interface 260 displays the “Search for Case” screen. In step 3024, the user 200/220 provides data against the interested search parameters. In step 3025, the user interface 3025 requests search results, based on the role of the user. In step 3026, the CDSS service 240 performs the authentication and validation functions. In step 3027, CDSS service 240 seeks to retrieve the appropriate results based on the search criteria. In step 3028, the data store 250 returns data matching the search criteria. In step 3029, the user interface 260 displays search results that are appropriate for the user role. In step 3030, the user 200/220 may view the search results. If the case of interest is not found, the process returns to step 3022. If the case is found, the user 200/220 may select the case from the search results in step 3031. In step 3032, the CDSS service 240 seeks to pull the case information based on the case identifier. In step 3033, the data store 250 returns the data matching the search criteria. In step 3034, the “Review/Update Case” functionality is invoked by the user interface 260, in step 3034. In step 3035, the user 200/220 can view and edit the case information.

FIG. 4N is an exemplary “Input Search parameters” screen. Here, the user can search for, e.g., cases based on parameters as indicated above. FIG. 40 is an exemplary “Search Results” screen. The cases that match the search criteria provided by the user may be displayed as shown on this screen.

FIG. 3C is a flow diagram illustrating an exemplary workflow of the “View Dashboard” feature that may be part of one embodiment of the Physician/Provider Toolkit of the Clinical Decision Support System. In step 3036, the user 200/220 may access the dashboard function from the navigation list. In step 3037, the CDSS Service 240 may perform authentication and validation. In step 3038, the CDSS Service 240 seeks to retrieve all actionable cases, which are returned by the data store 250 in step 3039. In step 3040, the user interface 260 displays the pending cases depending on the user role. In step 3041, the user 200/220 may view the actionable case list. If the case is not found, in step 3045, the user 200/220 can access the search function. If the case is found, in step 3042, the user 200/220 can select the case from the search results. In step 3043, the CDSS Service 240 seeks to retrieve the case information based on the case identifier. In step 3044, the data store 250 returns the data matching the search criteria. In step 3046, the user interface 260 invokes the review/update case functionality. In step 3047, the user 200/220 may view/edit the case information in step 3047. FIG. 4P is an exemplary screen illustrating the dashboard feature.

FIG. 3D is a flow diagram illustrating an exemplary workflow of the “Review/Update Case” feature that may be part of one embodiment of the Physician/Provider Toolkit of the Clinical Decision Support System. The physician/provider can retrieve any case from the Search and Dashboard functions. Once retrieved, the physician/provider will be able to make modifications to the case, in terms of the recreating treatment bundles; to resubmit their changes for preauthorization, or to save it for later processing; and to accept the preauthorization responses and complete the case or request for new treatment options against the case. In the exemplary embodiment, the illustrative screens for the Create case function (described above) apply for this function; multiple iterations of requesting new treatment options and processing for preauthorization are allowed and captured by the system.

Thus, with reference to FIG. 3D, if the case is not actionable, the user interface 260 displays the case information with the edit function disabled, and the process ends. If the case is actionable, the user interface 260 displays the case information with the edit function enabled. At this point, the user 200/220 can request more treatment options, create a custom package or submit a treatment option for preauthorization. If requesting more treatment options, in step 3051, CDSS service 240 requests treatment options. In step 3052, the evidence based intelligent decision system 230 provides the treatment options, which are then displayed in step 3050 by the user interface 260. The treatment options are then displayed (edit enabled) in step 3049 and the process begins again. If creating a custom package, in step 3055, the user interface 260 allows the user to select procedures from suggested bundles and/or add their own procedures to a bundle. In step 3056, the user can choose a custom procedure. Thereafter, in step 3057, the request is submitted for preauthorization by the CDSS service 240, and the case information is updated in step 3053 by the data store. Also, in step 3054, the treatment option information is persisted against the case by CDSS service 240, and the case information is updated in step 3053.

The user can retrieve all cases that are waiting on further action from the user through the Dashboard. For example, cases that do not have at least one preauthorization request in Submitted, Complete or Cancelled status will be considered actionable cases. The actionable cases are displayed, e.g., as illustrated in FIG. 4P, with the hierarchy of Treatment Options Requests and Preauthorization Requests shown for every case. The user can then choose any case in the displayed list for reviewing and any further updating.

FIG. 3E, illustrates the System-User Interaction workflow for one exemplary embodiment in which the system can be used. In step 5058, patient data is collected from, e.g., the referring physician, the patient himself, the patient electronic medical record maintained by the physician, sources with data reflecting a more comprehensive view of the patient over time (e.g., a longitudinal patient record or “LPR”), and other sources, such as the patient's health insurer. In step 5074, the CDSS system 240 may retrieve the patient data, which may be reviewed by a physician in step 5064. The physician may then decide if additional testing is required, in step 5062. If not, in step 5063, a determination is made as to whether the LPR should be updated. If so, in step 5073, the LPR is updated. If additional testing is not required, in step 5060, it is determined whether authorization is required. If not, a request for additional testing/treatment is sent to the referring physician in step 5059 and the process begins again. If authorization is required, in step 5061, a request is made. In step 5065, it is determined whether the request can be auto-authorized. If so, in step 5068 the CDSS system 240 captures the final treatment decision. If auto-authorization is not available, in step 5066, an approve/disapprove request is sent. In step 5067, if utilization management determines to disapprove the request, the process moves to step 5059 to have the additional testing performed. If approved, in step 5068, the final treatment decision is captured. CDSS system 240, in conjunction with evidence based decision intelligence system 230, may perform the functionalities described elsewhere herein, including performing authentication (step 5075), adding additional patient information for a transaction or query (step 5072), requesting evidence based options (step 5071), validating evidence based options and sources (step 5070), maintaining provider recommended options (step 5069), saving requests for later action (step 5076), and generating reports based on queries, responses and performance (step 5077). Evidenced based decision intelligence system 230 may determine evidence based options and determine whether additional information is required (step 5079), in which case additional testing may be ordered in step 5059.

A more detailed description of the treatment bundles used in connection with of one embodiment of the present invention is now described. Treatment bundles allow for a series of treatments and/or service procedures to be considered, packaged and suggested for a particular ailment or condition. The treatment bundle represents a set of treatment combinations that will enable the patient to obtain appropriate treatment and/or procedures, taking into consideration all aspects of the patient's medical history, personal preferences, and any results of ongoing treatment. In addition to treatment bundles recommended to the provider/physician (e.g., by the evidenced based intelligent decision system), the provider/physician can create his own custom treatment bundle(s). This allows for physicians/providers to exercise flexibility based on their experience, the patient's history and preferences to recommend the most effective treatment bundle for the patient's diagnosis. Such a custom created treatment bundle may further be validated using the CDSS service 240, against available medical literature, to check for any contradicting effects between the various procedures that were combined into the custom created bundle, overlaid with the patient's medical history and preferences.

Thus, the CDSS service 240 has available to it data relating to the patient, and any additional information provided by the provider/physician and, in connection with the evidence-based decision intelligence system 230, provides suggestions around possible combinations and appropriate sequencing of medical procedures/services to be rendered to the patient. Further, the provider/physician can select and/or add new treatment procedures to create a custom created bundle. Still further, the custom created treatment bundles may be validated using information relevant to the patient and based on relevant medical evidence, including current medical trends and advances. Validation can serve to bring to the attention of the provider/physician possible side effects or problems that may be encountered with the suggested treatment bundle.

Use of the treatment bundles may provide a number of advantages. For example, rather than considering treatments as individual procedures that help resolve a particular condition, a treatment bundle defines a series of procedures and services that need to be rendered to provide an appropriate treatment regimen for the condition of the patient. The absence of being able to handle treatments as a bundle causes inconvenience to providers/physicians, given that requests for approval/preauthorization, claim submission, and payment requests, including follow up processes, must be handled multiple times, per procedure/treatment. Use of treatment bundles allows for many processes, e.g., preauthorization, claims submission and payments requests etc., to be performed at a bundle level, rather than at a procedure level. Predetermined or custom-created treatment bundles can be considered as a single entity towards submission for further preauthorization requests, claim submissions and requests for payments to the providers/physicians, by the health care payor. Thus, a single request for preauthorization of a treatment bundle may be made, as well as a single claim or request for payment. The payor may then assign each treatment bundle a unique identifier for purposes of internal processing. The payor may process each procedure within the bundle individually, and issue individual payment to providers as appropriate.

An exemplary screen pursuant to which treatment bundle(s) may be presented to a provider/physician, and in which a provider/physician may create his own bundle, is shown in FIG. 4G. An exemplary screen illustrating a message that may be shown to a provider/physician upon validation of a treatment bundle is shown in FIG. 4Q.

With reference to FIG. 3F, a flow chart illustrating an exemplary method of the present invention is shown. In step 3060, data describing a request to identify a treatment option for a patient associated with a diagnosis for the patient is received. In response to the request, data describing a treatment bundle is identified, in step 3061. The treatment bundle comprises a plurality of treatments, the treatments comprising a one or more of a procedure, a test, a medication, and a therapy. This information is then transmitted to the physician/provider who can determine which treatment bundle(s) are appropriate for the patient. The patient then undergoes the activities represented by the treatment bundle. An insurance claim for the treatment bundle is submitted and, in step 3063, the insurance claim for the treatment bundle is processed. In some embodiments, at least some of the activities represented by the treatment bundle require preauthorization. In these embodiments, a request for pre-authorization of the treatment bundle is processed, in step 3064. In other embodiments, after processing of the claim, payment to one or more providers providing services associated with the treatment bundle is initiated, in step 3065.

With reference to FIG. 3G, a flow chart illustrating an exemplary method of the present invention is shown. In step 3066, data describing a treatment bundle for a patient is received, e.g., from a provider/physician who has created his own custom treatment bundle. The treatment bundle includes a plurality of treatments, the treatments comprising a one or more of a procedure, a test, a medication, and a therapy. Once the patient undergoes the activities represented by the treatment bundle, an insurance claim for the treatment bundle submitted and, ultimately, processed, in step 3067. In other embodiments, as referenced above, a request for pre-authorization of the treatment bundle is processed, in step 3068. In still other embodiments, payment to one or more providers providing services associated with the treatment bundle is initiated, in step 3069. In further embodiments, data describing validation of the data describing the treatment bundle based on one or both of medical literature information and patient medical history information is received, in step 3070.

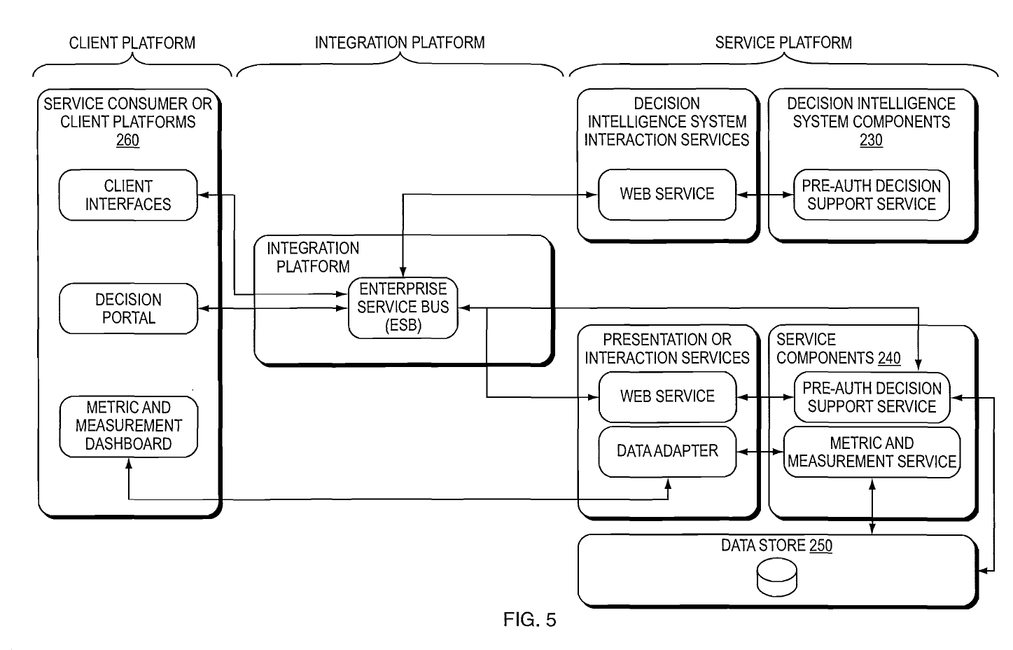

An exemplary system is now described with reference to FIG. 5. The system may comprise three platforms: a client platform, an integration platform, and a service platform. The client platform may include the client interfaces, the decision portal and the metric and measurement dashboard of CDSS UI 260. The integration platform may include an enterprise service bus. Service platform may include CDSS service 240, which may include interaction services and system components, and evidence based decision intelligence system 230, which may include interaction services and system components.

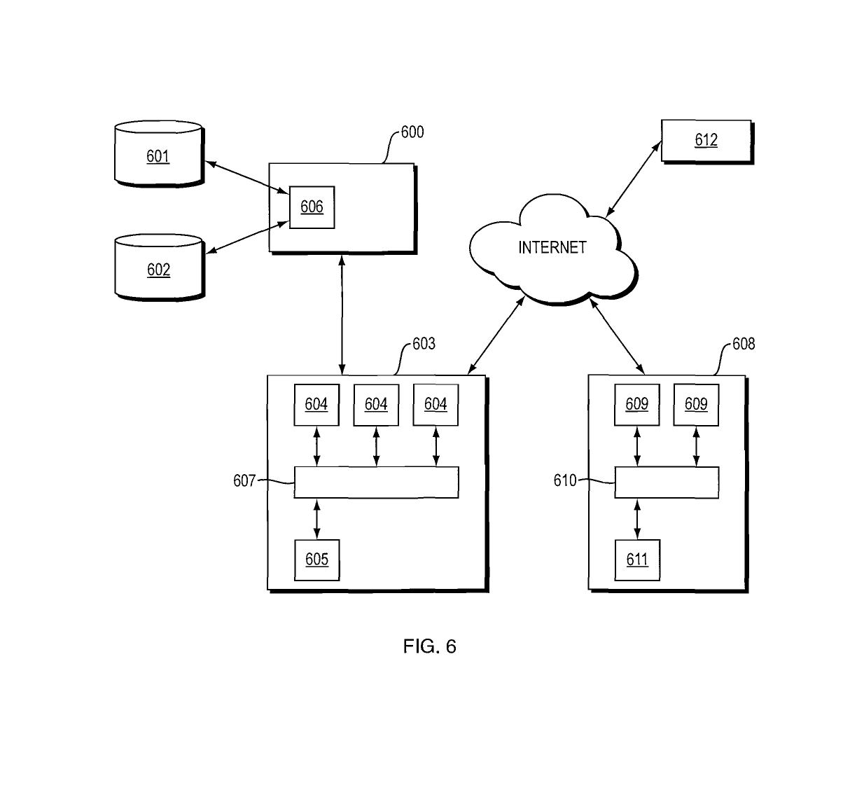

Exemplary hardware and software employed by the systems discussed herein are now generally described with reference to FIG. 6. Database server(s) 600 may include a database services management application 606 that manages storage and retrieval of data from the database(s) 601, 602. The databases may be relational databases; however, other data organizational structure may be used without departing from the scope of the present invention. One or more application server(s) 603 are in communication with the database server 600. The application server 603 communicates requests for data to the database server 600. The database server 600 retrieves the requested data. The application server 603 may also send data to the database server for storage in the database(s) 601, 602. The application server 603 comprises one or more processors 604, computer readable storage media 605 that store programs (computer readable instructions) for execution by the processor(s), and an interface 607 between the processor(s) 604 and computer readable storage media 605. The application server may store the computer programs referred to herein.

To the extent data and information is communicated over the Internet, one or more Internet servers 608 may be employed. The Internet server 608 also comprises one or more processors 609, computer readable storage media 611 that store programs (computer readable instructions) for execution by the processor(s) 609, and an interface 610 between the processor(s) 609 and computer readable storage media 611. The Internet server 608 is employed to deliver content that can be accessed through the communications network. When data is requested through an application, such as an Internet browser, the Internet server 608 receives and processes the request. The Internet server 608 sends the data or application requested along with user interface instructions for displaying a user interface.

The computers referenced herein are specially programmed, in accordance with the described algorithms, to perform the functionality described herein.

The non-transitory computer readable storage media that store the programs (i.e., software modules comprising computer readable instructions) may include volatile and non-volatile, removable and non-removable media implemented in any method or technology for storage of information such as computer-readable instructions, data structures, program modules, or other data. Computer readable storage media may include, but is not limited to, RAM, ROM, Erasable Programmable ROM (EPROM), Electrically Erasable Programmable ROM (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computer system and processed.

The computer applications described herein may be hosted in a public, private or hybrid Internet cloud environment, in some embodiments.

What is claimed is:

1. A computer implemented method comprising:
receiving data describing a request to identify a treatment option for a patient associated with a diagnosis for the patient;
in response to the request, identifying data describing a treatment bundle, the treatment bundle comprising a plurality of treatments, the treatments comprising a one or more of a procedure, a test, a medication, and a therapy; and
processing an insurance claim for the treatment bundle.

2. The method of claim 1, further comprising:
processing a request for pre-authorization of the treatment bundle.

3. The method of claim 1, further comprising:
initiating payment to one or more providers providing services associated with the treatment bundle.

4. A computer implemented method comprising:
receiving data describing a treatment bundle for a patient, the treatment bundle comprising a plurality of treatments, the treatments comprising a one or more of a procedure, a test, a medication, and a therapy; and
processing an insurance claim for the treatment bundle.

5. The method of claim 4, further comprising:
processing a request for pre-authorization of the treatment bundle.

6. The method of claim 4, further comprising:
initiating payment to one or more providers providing services associated with the treatment bundle.

7. The method of claim 4, further comprising:
receiving data describing validation of the data describing the treatment bundle based on one or both of medical literature information and patient medical history information.

8. A non-transitory computer-readable storage medium that stores instructions which, when executed by one or more processors, cause the one or more processors to perform a method comprising:
receiving data describing a request to identify a treatment option for a patient associated with a diagnosis for the patient;
in response to the request, identifying data describing a treatment bundle, the treatment bundle comprising a plurality of treatments, the treatments comprising a one or more of a procedure, a test, a medication, and a therapy; and
processing an insurance claim for the treatment bundle.

9. The non-transitory computer-readable storage medium of claim 8, the method further comprising:
processing a request for pre-authorization of the treatment bundle.

10. The non-transitory computer-readable storage medium of claim 8, the method further comprising:
initiating payment to one or more providers providing services associated with the treatment bundle.

11. A non-transitory computer-readable storage medium that stores instructions which, when executed by one or more processors, cause the one or more processors to perform a method comprising:
receiving data describing a treatment bundle for a patient,
the treatment bundle comprising a plurality of treatments, the treatments comprising a one or more of a procedure, a test, a medication, and a therapy; and
processing an insurance claim for the treatment bundle.

12. The non-transitory computer-readable storage medium of claim 11, the method further comprising:
processing a request for pre-authorization of the treatment bundle.

13. The non-transitory computer-readable storage medium of claim 11, the method further comprising:
initiating payment to one or more providers providing services associated with the treatment bundle.

14. The non-transitory computer-readable storage medium of claim 11, the method further comprising:
receiving data describing validation of the data describing the treatment bundle based on one or both of medical literature information and patient medical history information.

15. A system comprising:
memory operable to store at least one program; and
at least one processor communicatively coupled to the memory, in which the at least one program, when executed by the at least one processor, causes the at least one processor to:
receive data describing a request to identify a treatment option for a patient associated with a diagnosis for the patient;
in response to the request, identify data describing a treatment bundle, the treatment bundle comprising a plurality of treatments, the treatments comprising a one or more of a procedure, a test, a medication, and a therapy; and
process an insurance claim for the treatment bundle.

16. The system of claim 15, wherein the processor is further caused to:
process a request for pre-authorization of the treatment bundle.

17. The system of claim 15, wherein the processor is further caused to:
initiate payment to one or more providers providing services associated with the treatment bundle.

18. A system comprising:
memory operable to store at least one program; and
at least one processor communicatively coupled to the memory, in which the at least one program, when executed by the at least one processor, causes the at least one processor to:
receive data describing a treatment bundle for a patient,
the treatment bundle comprising a plurality of treatments, the treatments comprising a one or more of a procedure, a test, a medication, and a therapy; and
process an insurance claim for the treatment bundle.

19. The system of claim 18, wherein the processor is further caused to:
process a request for pre-authorization of the treatment bundle.

20. The system of claim 18, wherein the processor is further caused to:
initiate payment to one or more providers providing services associated with the treatment bundle.

21. The system of claim 18, wherein the processor is further caused to:
receive data describing validation of the data describing the treatment bundle based on one or both of medical literature information and patient medical history information.
